(19) United States
(12) Patent Application Publication
(10) Pub. No.: US 2019/0287103 A1
(43) Pub. Date: Sep. 19, 2019

(54) A COMPUTER SYSTEM AND A METHOD OF SECURE DATA TRANSFER BETWEEN UNSECURED PARTIES

(71) Applicant: GALA TECHNOLOGY LIMITED, SOUTH YORKSHIRE (GB)

(72) Inventor: Jason Mace, South Yorkshire (GB)

(21) Appl. No.: 16/334,902

(22) PCT Filed: Sep. 19, 2017
(86) PCT No.: PCT/GB2017/052783

§ 371 Date: Mar. 20, 2019

(30) Foreign Application Priority Data
Sep. 20, 2016 (GB) 1615980.8

(51) Int. Cl. G06Q 20/38; G06Q 30/06; G06Q 20/10; G06Q 20/42

(52) U.S. Cl. CPC G06Q 20/38215; G06Q 30/0635; G06Q 20/388; G06Q 20/425; G06Q 20/102

(57) ABSTRACT

A computer system for secure data transfer between unsecured parties is configured to generate a unique transfer code (1302) that is assigned to order details. A message (1304) containing the unique order transfer code (1302) is sent as well as a request to return the unique order transfer code. A received unverified code is checked (1306) against the unique order transfer code. Then, either the unique order transfer code (1302) is rejected as false and access is denied, or the unique order transfer code (1302) is accepted and the entity to which the order details are applied is directed to an appropriate platform.

### FIELD OF THE INVENTION

The present invention relates to a method of secure data transfer between unsecured parties.

### BACKGROUND OF THE INVENTION

In telephone commerce, orders are taken over the telephone. This results in the technical problem of how to securely transfer confidential information between unsecured parties such as from a customer making an order to another party.

UK patent No. GB2,473,376 in the name of Semafone Ltd describes a system that is widely used. An equivalent patent has also granted in the US as U.S. Pat. No. 8,750,471 for this system.

As disclosed in UK patent No. GB2,473,376 and referring to FIG. 1, in known telephone systems, a caller 10 communicates via a telephone network 15 (comprising one or more telephone exchanges 17) with an agent 20 in a call centre 25. During the communication, caller 10 may be required to participate in a transaction with entity 30 which requires the sensitive data to be passed to the entity 30. In current systems this commonly requires agent 20 to facilitate the transaction and allows them to be privy to the sensitive data.

Upon the caller 10 deciding to make a purchase offered by the agent 20, the agent 20 may invite the caller 10 to pay for the purchase electronically and set up the transaction with the caller's bank (entity 30). Typically, this will involve the caller 10 providing the agent 20 with sensitive details such as a debit or credit card number (and associated verification details, such as the card issue number, card expiry date and card security code), and the agent 20 relaying these details to a bank 30. This assumes the agent can be trusted, which unfortunately is not always the case. In some systems, for ease of input and to increase security, there is the facility to allow the caller 10 to input numeric information by means of DTMF (dial-tone multi-frequency) or touch-tones. However, there have been cases where these tones have been recorded by untrustworthy agents 20.

UK patent No. GB2,473,376 cited above describes a technical solution to this problem. UK patent No GB2,473,376 broadly discloses an arrangement which allows a caller to perform a transaction via telephone with a third party via a call centre without having to disclose the customer's confidential information to the call centre. Broadly, the patent's solution is for the customer to dial in using the telephone on which they are making an order to a call centre agent using dial tones generated by the telephone to provide confidential information, such as payment information (such as credit or debit card numbers). In the arrangement described, the dial tones generated by the customer's telephone are masked to prevent the call centre from recording the key specific tones.

FIG. 2 shows the telephone call processing system of UK patent No. GB2,473,376. In this arrangement a caller 10 communicates via a telephone network 15 (comprising one or more telephone exchanges 17) with an agent 20 in a call centre 25. The telephone call from the caller 10 to the agent 20 is routed via a telephone call processor 40, located in the call centre 25. Call processor 40 is an intermediary for all such calls between caller 10 and agent 20 and is arranged such that the agent 20 has no means by which to circumvent the call processor 40 and interact with the caller 10 directly. Call processor 40 acts to modify characteristics of the telephone call or signal from the caller 10 to the agent 20 and to route data to the entity 30 such that sensitive information from the caller 10 is barred from reaching the agent 20 whilst allowing agent 20 to assist caller 10 in facilitating the interaction with entity 30. The modification of the call characteristics is described as ideally done only during those times when sensitive data is being transmitted by the caller 10.

In other words, the call processor 40 forms part of the telephone link between the caller 10 and the agent 20. The equipment required for the call processor is bespoke hardware for each implementation. The bespoke hardware is made dependent on the particular telephone system used by the call centre. There are a very large number of call centre variants. Furthermore, each bespoke hardware arrangement is extremely complex and requires the use of specialist signal detection and voice processing equipment.

### SUMMARY OF THE INVENTION

Examples of the present disclosure provide a technical solution to the technical problem described above. The system and method of the present disclosure provide a technical solution to the technical problem of securely transferring confidential information between unsecured parties in relation to a transaction over the telephone that is simple to implement without requiring bespoke hardware for each different call centre.

Arrangements are described in more detail below and broadly take the form of a computer system for secure data transfer between unsecured parties, the computer system is configured to generate a unique transfer code that is assigned to order details. A message containing the unique order transfer code is sent as well as a request to return the unique order transfer code. A received unverified code is checked against the unique order transfer code. Then, either the unique order transfer code is rejected as false and access is denied, or the unique order transfer code is accepted and the entity to which the order details are applied is directed to an appropriate platform. In more detail, a method of secure data transfer between unsecured parties in a system is described. The method comprises the steps of: receiving order details from an order generator, the order details comprising at least a Person to be billed's information and order information, storing the order details in the database, using the Person to be billed's information to generate a communication to a Person to be billed, forwarding the Person to be billed to a payment platform to complete transaction, awaiting confirmation of successful payment from the payment platform, and generating and sending a communication of the successful payment to the order generator.

Aspects of the present invention are defined by the independent claims below to which reference should now be made. Optional features are defined by the dependent claims.

According to a first aspect of the present disclosure, there is provided a method of secure data transfer between unsecured parties in a system comprising; at least a server, a database, and network communications. The method comprises the steps of:
1. Receiving order details from an order generator (typically a company who are intent on selling a product), the order details comprising at least a Person to be billed's information (the person to be billed typically being a customer of the aforesaid company) and Order information (any and all information required for fulfilling the order, such as product requested and delivery information).
2. Storing the order details in the database, to keep a record of the order.
3. Generating a unique order transfer code and assigning the unique order transfer code to the order details recorded in the database in order to allow identification by the system of that specific order.
4. Using the Person to be billed's information to generate a message to a Person to be billed, the message containing the unique order transfer code, and sending the message containing the unique order transfer code to the Person to be billed. This provides an order reference for the Person to be billed to refer to the order.
5. Requesting the Person to be billed to return the unique order transfer code, checking a received unverified code against the unique order transfer code held in the record and verifying the unique order transfer code, then either rejecting the unique order transfer code as false and denying access to the Person to be billed, or accepting the unique order transfer code and forwarding the Person to be billed to a payment platform to complete the transaction. This provides an initial first verification step ensuring that the only recipient of the unique order transfer code can progress the order.
6. Awaiting confirmation of successful payment from the payment platform and generating and sending a communication of the successful payment to the order generator. The system acts as an intermediary putting the person to be billed in direct contact with the payment gateway and allows the transaction to be carried out without the person to be billed disclosing information to any other party other than the payment gateway.

The order details can comprise any of the information from the following list; first name of the person to be billed, second name of the person be billed, the billing address, the phone number of the person being billed; the order recipient's first name, the order recipient's second name, the order recipient's address; an email address; a description of the transaction; the currency; the amount of the transaction. Advantageously, the inclusion of a secondary, separate delivery address means that the person to be billed does not have to receive the order at their authorised billing address but may choose to accept delivery at an address of their choice, furthermore they may give an order recipient name instead of their own.

The system may suitably be part of an online network or cloud computer system. The system need not be tied to a single geographic location but may be used by a number of separate order generators (i.e. different companies or branches within a company).

Alternatively, the order generator's device and the server are a single unitary device. Here, the system may be used by a single order generator such as a sole trader.

Suitably, the method, and any data sent or received in the method is encrypted to further ensure the safety of the confidential information.

Finally, the person to be billed can be in substantially real time communication with the order generator. Here a customer can place their order of the telephone and then be talked step by step through the payment system and the company, on the other end of a telephone line, can watch the verification status of the customer. Once the payment is complete the company may then inform the customer in real time that the transaction has been successful and their order is being prepared for dispatch.

A computer terminal may be provided for use with the computer system for secure data transfer between unsecured parties. The terminal may be configured to: receive a message in relation to a person to be billed associated with a transaction associated with a telephone order, the message containing a unique order transfer code; request the person to be billed to return the unique order transfer code; and send the unique order transfer code to a computer system to complete the transaction.

A method for use with a computer system for secure data transfer between unsecured parties may be provided. The method, carried out on a computer terminal, may comprise: receiving a message in relation to a person to be billed associated with a transaction associated with a telephone order, the message containing a unique order transfer code; requesting the person to be billed to return the unique order transfer code; and sending the unique order transfer code to a computer system to complete the transaction.

The computer terminal described above may be a smart phone, tablet computer, laptop computer or desktop computer.

### BRIEF DESCRIPTION OF THE DRAWINGS

For a better understanding of the invention and to show how the same may be carried into effect, there will now be described by way of example only, specific embodiments, methods and processes according to embodiments of the present invention with reference to the accompanying drawings in which:

FIG. 1 (prior art) is a schematic diagram depicting the prior art system of making a payment over the telephone.

FIG. 2 (prior art) is a schematic diagram depicting the prior art system of making a payment over the telephone.

FIG. 3 is a schematic of a computer embodying an aspect of the present disclosure.

FIG. 4 is a flow chart embodying an aspect of the present disclosure.

FIG. 5 shows an example upload invoice embodying an aspect of the present disclosure.

FIG. 6 shows the verification status of the customer data pre-verification embodying an aspect of the present disclosure.

FIG. 7 shows an invitation for a customer to commence verification of their information embodying an aspect of the present disclosure.

FIG. 8 shows a request for a unique reference number embodying an aspect of the present disclosure.

FIG. 9 shows a customer visible order summary embodying an aspect of the present disclosure.

FIG. 10 depicts a list of available payment methods embodying an aspect of the present disclosure.

FIG. 11 (prior art) shows a prior art verification process.

FIG. 12 shows the verification status of the customer data post-verification embodying an aspect of the present disclosure.

FIG. 13 shows an example of the present disclosure in the form of a flow chart.

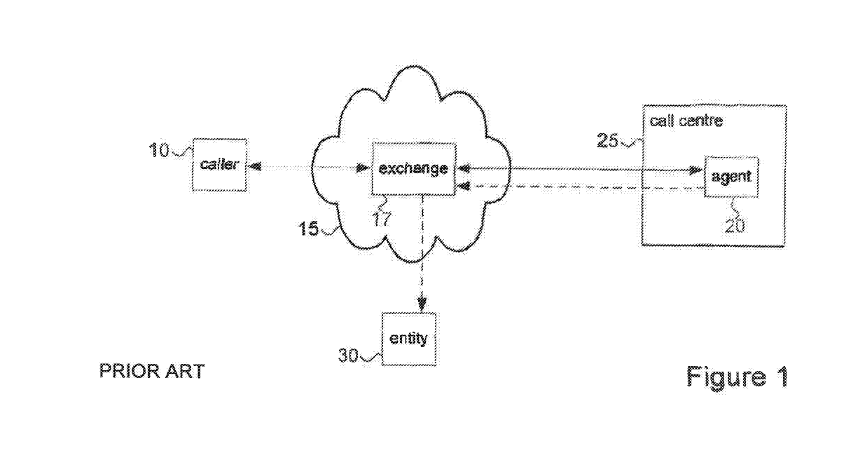

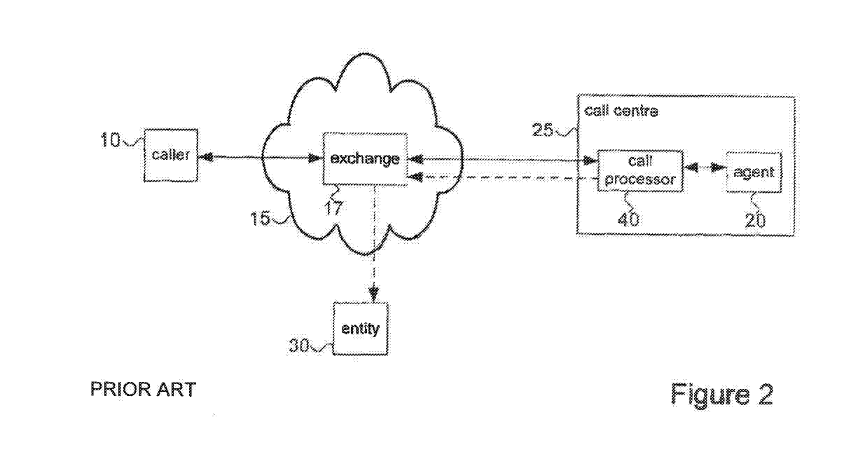

### DETAILED DESCRIPTION OF THE EMBODIMENTS

There will now be described by way of example a specific mode contemplated by the inventors. In the following description numerous specific details are set forth in order to provide a thorough understanding. It will be apparent however, to one skilled in the art, that the present invention may be practiced without limitation to these specific details. In other instances, well known methods and structures have not been described in detail so as not to unnecessarily obscure the description.

The words “comprising/comprises” and the words “having/including” when used herein with reference to the present invention are used to specify the presence of stated features, integers, steps or components but does not preclude the presence or addition of one of more other features, integers, steps, components or groups thereof.

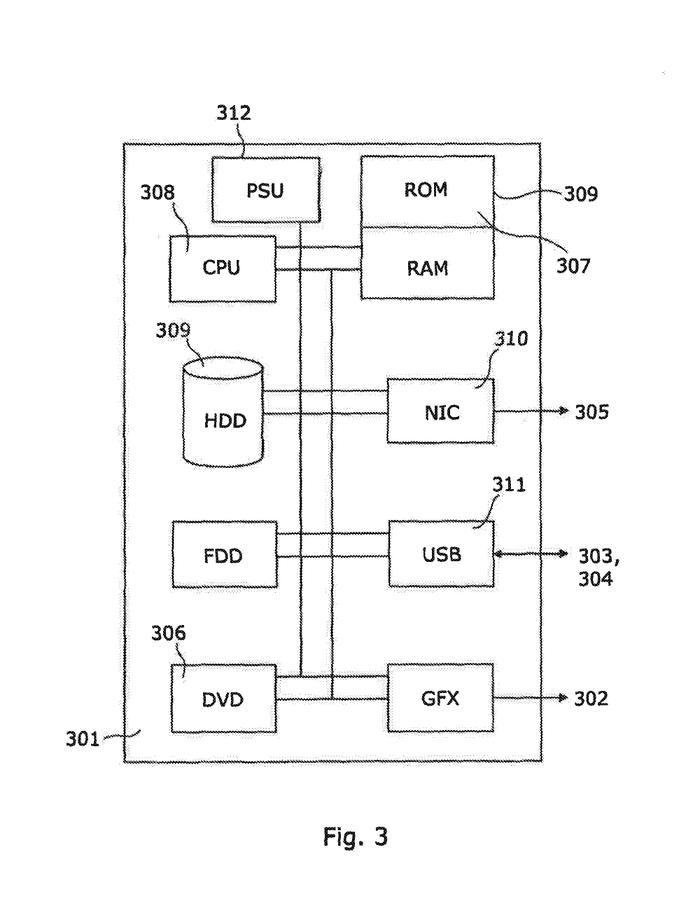

With reference to FIG. 3 a typical hardware architecture of the website host server, sales person's device or customer's device is illustrated by way of non-limitative example. The terminal 301 is a data processing device configured with a data processing unit 308, data outputting means such as a video display unit (VDU), data inputting means such as human interface devices 304, commonly a keyboard and a pointing device (mouse), as well as the VDU itself if it is a touch screen display, and data inputting/outputting means such as the wired or wireless network connection(s) to the communication network(s) 305, and a magnetic data-carrying medium reader/writer 306.

Within the data processing unit, a central processing unit (CPU, 308) provides task co-ordination and data processing functionality. The CPU is preferably a multi-core processor having several cores, each adapted to process a respective data processing thread simultaneously with the others. Examples of multi-core processors include Intel i3, i5 and i7 processors manufactures by the Intel Corporation of Santa Clara, Calif., USA and the AMD X2, X4 and X6 manufactured by the Advanced Micro Devices Corporation of Sunnyvale, Calif., USA.

Instructions and data for the CPU 308 are stored in memory means. Memory means comprises non-volatile random-access memory (‘NVRAM’ 307) or Read-Only Memory (ROM′ 309), in which a first set of instructions for the CPU 308, known as the Basic Input/Output System (BIOS) is permanently stored for initializing the terminal hardware whenever it is started up. Memory means further comprises Random-Access Memory (‘RAM’) in which a second set of instructions for the CPU 308, known as the Operating system (‘OS’), is loaded from a Hard Disk Drive (‘HDD’ 309) unit for using the terminal whenever it is started up. The OS is for instance Windows 7 Professional, distributed by the Microsoft Corporation of Redmond, Wash., USA.

The HDD (309) facilitates non-volatile storage of the instructions and the data in data files. A wired and/or wireless network interface card (NIC 310) provides the interface to the network connection(s) 305. A universal serial bus (USB 311) input/output interface facilitates connection to the keyboard and pointing devices, as well as a multitude of further USB configured devices, for instance a camera (not shown) for providing images or video to upload to a website.

All of the above components are connected to a data input/output bus, to which the magnetic data-carrying medium reader/writer and optical data carrying medium reader/writer are also connected. A video adapter receives CPU instructions over the bus for outputting processes data to the VDU. All the components of the data processing unit are powered by a power supply unit 312, which receives electrical power from a local mains power source and transforms the electrical power according to component ratings and requirements.

The hardware architecture of the server, sale person's device or customer device described hereinbefore corresponds generally to a personal computer, however it will be readily understood by the person skilled in the art from the foregoing that the inventive concept will be easily adapted to any networkable data processing terminal having an alternative hardware architecture providing at least comparable data processing and communication functionalities, including smart mobile telephones, and tablet computer devices.

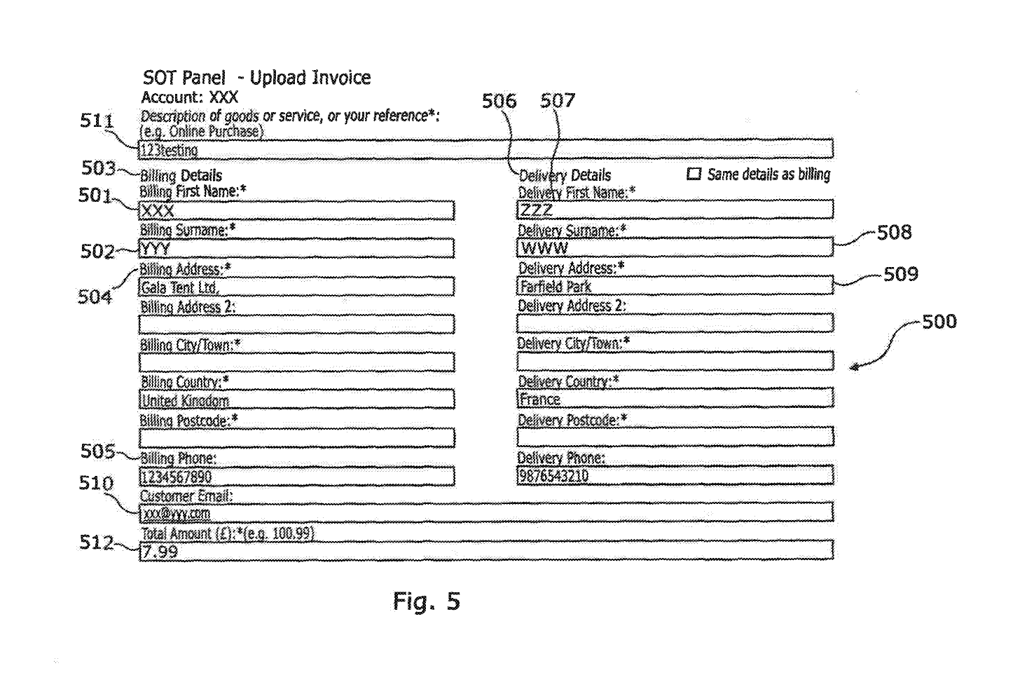

The computer system, server, sale person's device or customer device can therefore receive, store, process and communicate electronic data pertinent to process a customer 102 order. Thus, with reference to FIG. 5, data including, but not exclusively consisting of, the first 501 and second 502 names of the person to be billed 505, the billing address 504, the phone number 505 of the person being billed 505; the order recipient's 506 (i.e. the person to which the order is being delivered or the intended recipient if the product is a service) first 507 and second 508 names, the order recipient's address 509; an email address 510; description of the transaction 511; the currency (e.g. GBP or USD); the amount of the transaction 512 (e.g. 1.25 units where “units” represent the currency).

The distinction between the person to be billed 503 and the order recipient 506 is to be highlighted. The person to be billed is intended to be the person who pays for the order. The order recipient is the beneficiary of the goods or services ordered. The person to be billed and the order recipient may be the same physical entity (such as a person buying an item for their own enjoyment). Alternatively, the person to be billed and the order recipient may be separate entities (physically and geographically, such as a first person, with a first address, placing an order for a second person at a second address).

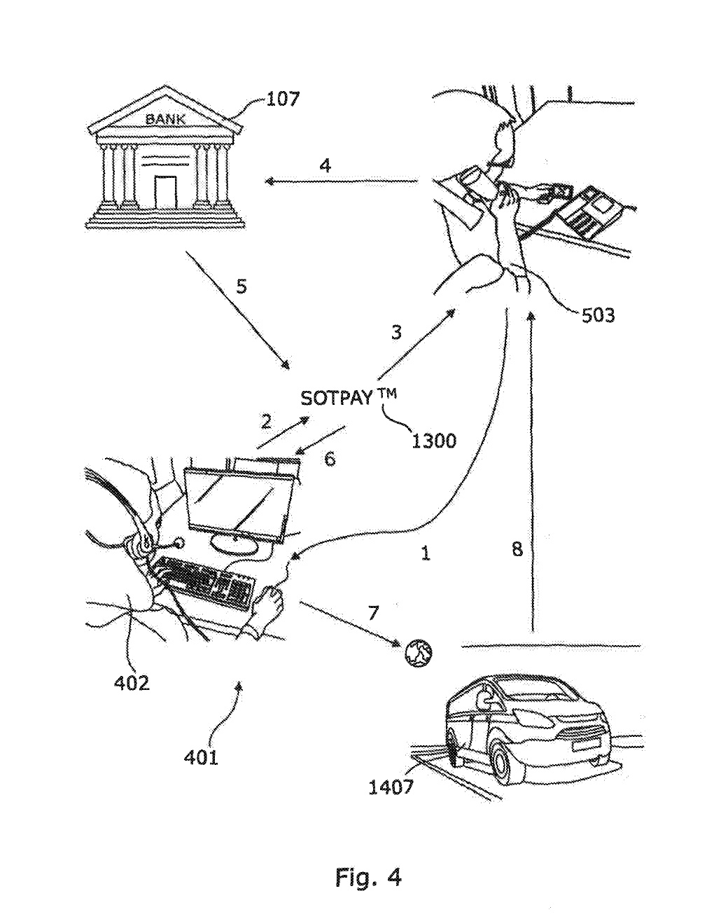

Referring to FIG. 4 there is presented an outline operation of the present disclosure.

A customer 503 wishing to place an order with a company 402 by telephone calls the company 402. The customer 503 and company 402 may be in 2-way direct communication throughout the complete working of the present method, from placing the order, to the company 402 informing the customer 503 that the customer's 503 details have been verified and the customer's 503 order is being processed for immediate dispatch.

The company 402 takes, amongst other information necessary for raising and processing the order, the first 501 and second 502 names of the person to be billed 505, the billing address 504, the phone number 505 of the person being billed 505; the order recipient's 506 (i.e. the person to which the order is being delivered or the intended recipient if the product is a service) first 507 and second 508 names, the order recipient's address 509; an email address 510; description of the transaction 511; the currency (e.g. GBP or USD); the amount of the transaction 512 (e.g. 1.25 units where “units” represent the currency).

The aforesaid information is not intended to be a complete list, nor is it intended to be a prescription of the exact information taken. Only the information necessary for the transaction to be processed, such as, in suitable situations, only the person to be billed's 503 name 502, address 504, telephone number 505 and product details 511 need to be taken (in this instance the person to be billed 503 is also the order recipient 506, and therefore the address is both the billing 504 and delivery address 509).

The company 402 then raises a customer order transaction by inputting the aforesaid order details into a form 500 and the details are saved to a database 1301, as depicted in FIG. 5. The form 500 allows for the person to be billed 503 and the order recipient 506 to be separated with fields for both sets of information. Where the person to be billed 503 and the order recipient 506 are one and the same the information input into each set of fields will be the same (i.e. the billing address 504 and the delivery address 509 fields will contain identical information).

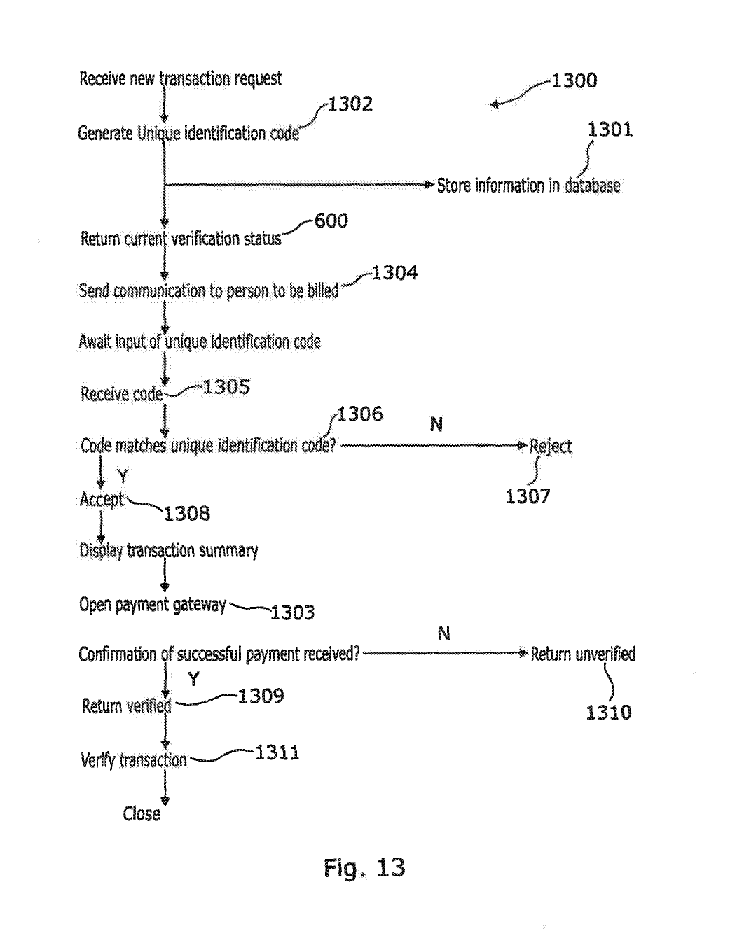

With reference to FIG. 13, once the form 500 data has been entered, the company 402 submits the order information 400 to the secure order transfer system 1300 which holds the order information in a database 1301 and registers a transaction.

The database 1301 storing the order information may be local to the company's server, (or personal computer in the instance of a sole trader) or a remote database located within a company intranet or extranet such as the world wide web depending on the set up of the system. Essentially, the form data 500 need not be kept local by may be transmitted as known in the art to any suitable location.

The database 1300 is then read and the new order identified. The order is assigned a unique identification code 1302 generated at random. Preferably, the unique identification code 1302 uses a random set of 13 characters selected from the following alphanumeric values: 23456789ABCDEFGHIJKLMNOPQRSTUVWXYZ.

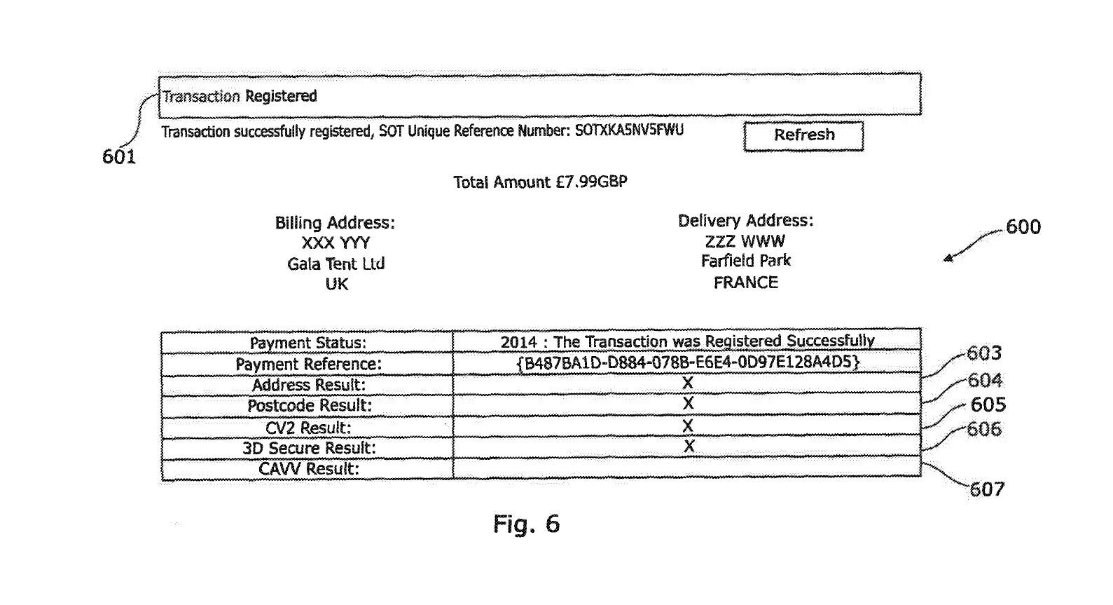

The secure order transfer system 1300 then displays a page 600 (see FIG. 6) to the company 402 showing the registered order transaction 601 and the current verification status 602 of the person to be billed's 503 information, including but not limited to verification of the billing address 603, billing post code 604, CV2 number verification 605, and other verification factors 606, 607. The page preferably refreshes periodically to provide near-live (real time) verification status information in order to allow the transaction to be processed as soon as possible following verification of the person to be billed's 503 credentials.

Once the unique identification code 1302 is generated the secure order transfer system 1300 raises the transaction with a payment gateway 1303. This is any prior art method of effecting payment over the internet, such as, but not limited to SagePay™, PayPal™, WorldPay™, and/or CreditCall™.

The secure order transfer system 1300, using the customer data 500 (see FIG. 5) lodged in the database 1301 and associated with that transaction, sends a message 1304 directly to the person to be billed 503. The message 1304 may be sent by any means whether, post, email, SMS text message, or by computer generated voice recording. Preferably, the message 1304 is sent by email or SMS text message as these methods are near instantaneous and are able to include live hypertext links to facilitate the working of the present invention. The use of email or SMS further allows the person to be billed 503 to remain in live contact with the company 402 by telephone and receive the message 1304 on a second device such as a personal computer.

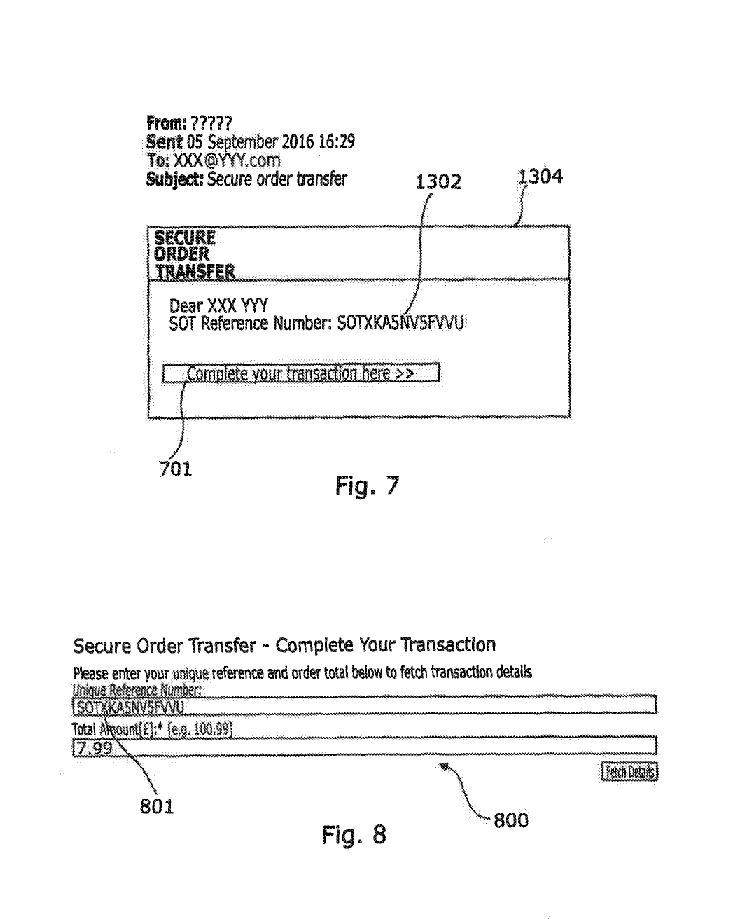

The message 1304 (see FIG. 7) to the person to be billed 503 comprises the unique identification code 1302 and a link 701 to a secure website 900 hosted by the secure order transfer system 1300 servers. The person to be billed 503 follows the link 701 to the secure website 900. The secure order transfer system 1300 prompts the person to be billed 503 to enter the unique identifier code 1302 (FIG. 8). Once a code has been entered 1305, the secure order transfer system 1300 checks 1306 the code against the database 1301 and determines if the unique code 1302 has been entered or whether an incorrect code has been entered.

If an incorrect code has been entered access is denied 1307 to the visitor (i.e. the secure order transfer system 1300 has determined that the entity entering the code is not the person to be billed 503 for a given transaction).

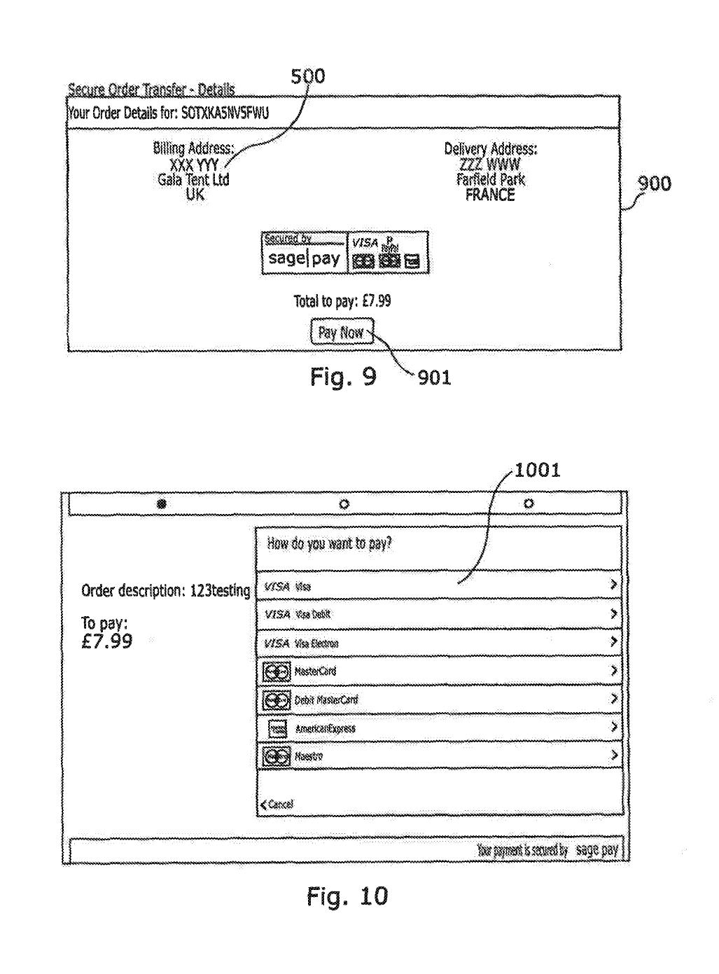

If a valid unique identified code 1302 has been entered, the visitor is validated 1308 as the person to be billed 503 (this is a distinct verification step and does not verify that the person to be billed 503 is verified with respect to order payment, simply that the visitor is the recipient of the unique identification code 1302 and grants access for the visitor to make the required payment as the person to be billed 503). The verified person to be billed 503 is then shown a form 900 (see FIG. 9) populated with the order data 500 recorded in the database 1301 with an invitation to complete the transaction (i.e. make payment).

The person to be billed 503 is able to review the order information 500 at this point and ensure the order data 500 is correct before progressing the order.

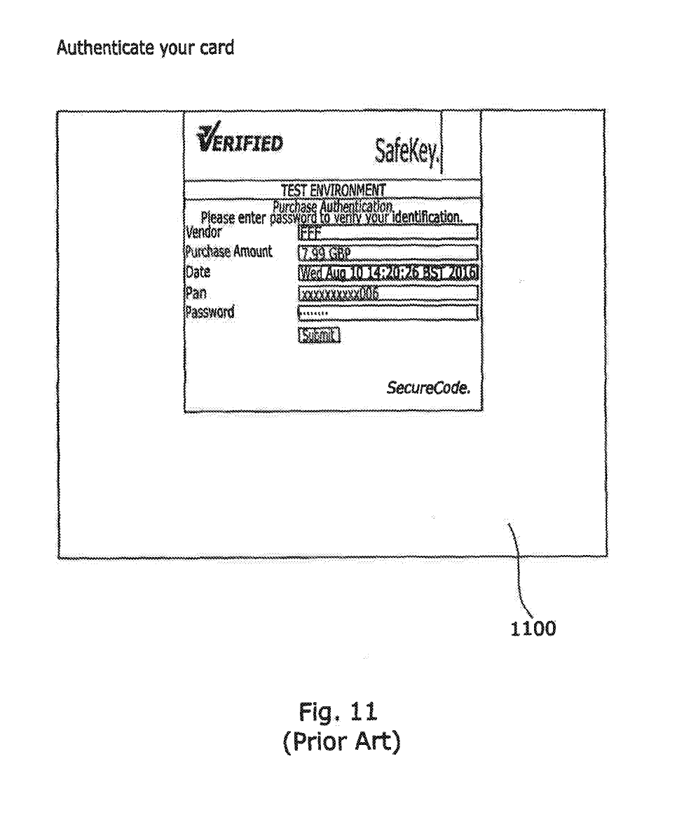

The person to be billed 503 is then able to select an option to pay 1001 (see FIG. 10) and is forwarded by the secure order transfer system 1300 to an appropriate payment gateway 1100 (see FIG. 11) and payment is taken in the normal way as per the prior art.

The payment gateway 1100 then returns confirmation of success 1309 or failure 1310 of the payment to the secure order transfer system 1300 which correspondingly logs this within the database 1301.

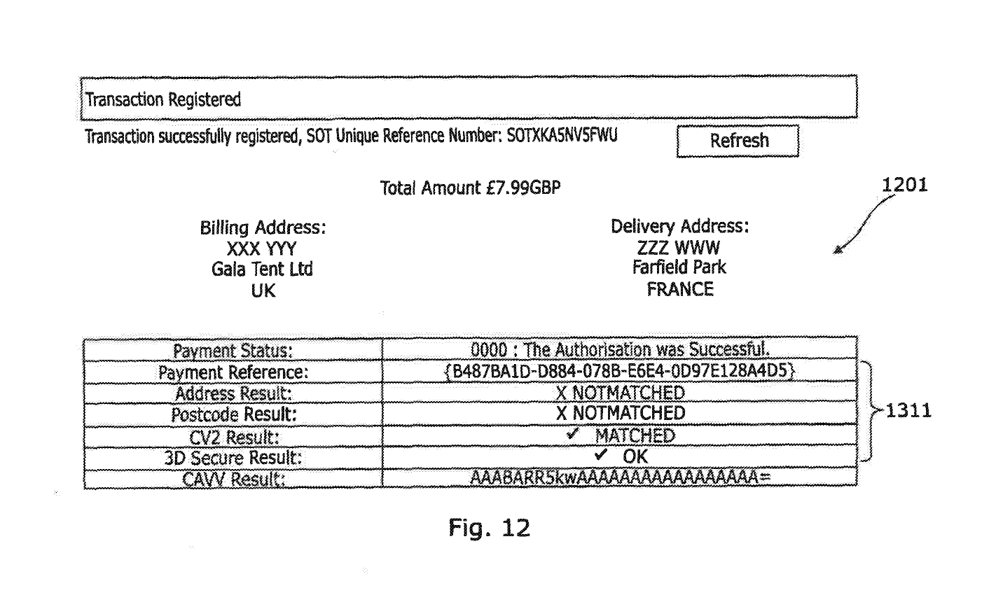

The secure order transfer system 1300 then updates the verification status 1311 on the updated page 1201 visible to the company 402. The updated verification status 1311 either confirms or denies the success of the transaction (see FIG. 12).

Once the company 402 has received validation of the transaction the person to be billed's 503 order may then be released for dispatch 1407 in confidence that full and successful payment has been taken.

The above references to the sending and receiving of communications or messages, unless specified otherwise, are made by application programming interface (API) calls. Any other suitable set of subroutine definitions may be used.

The program code used to implement the present invention may be Java™ or any other suitable language.

Furthermore the person to be billed 503 can be confident that their data is secure as at no time during the process is a disclosure of secure information to an unsecured party (such as the company 402) required. The company 402 did not need to record or store the sensitive information itself nor was it entered into the secure order transfer system 1300, but the person to be billed 503 entered their confidential payment information 103 only into the familiar prior art payment gateway 1100.

The above method has the primary advantage in that it allows a company 402 to process a “next day” transaction outside bank business hours and be confident that genuine and non-fraudulent payment has been made prior to releasing the person to be billed's 503 order for dispatch and subsequent delivery.

Likewise, the person to be billed 503 can be confident that their payment information 103 is secure and can also enjoy the added flexibility of requesting the delivery be made to a third party address without the company 402 raising the issue of fraud.

1. A computer system for secure data transfer between unsecured parties, the computer system being configured to:
receive order details from an order generator, the order details comprising at least: a person to be billed's information; and order information;
store the order details;
generate a unique order transfer code;
assign the unique order transfer code to the order details;
use the person to be billed's information to generate a message to a person to be billed;
send the message containing the unique order transfer code to the person to be billed;
request the person to be billed to return the unique order transfer code;
check a received unverified code against the unique order transfer code and verify the unique order transfer code, then either:
reject the unique order transfer code as false and deny access to the person to be billed, or
accept the unique order transfer code and forward the person to be billed to a payment platform to complete the transaction;
await confirmation of successful payment from the payment platform; and
generate and send a communication of the successful payment to the order generator.

2. A computer system according to claim 1 wherein the order details further comprise any of the information from the following list: first name of the person to be billed; second name of the person to be billed; the billing address; the phone number of the person being billed; the order recipient's first name; the order recipient's second name; the order recipient's address; an email address; a description of the transaction; the currency; the amount of the transaction.

3. A computer system as claimed in claim 2 wherein the billing address and the delivery address refer to different geographical locations.

4. A computer system as claimed in claim 1 wherein the computer system is part of an online network or cloud computer system.

5. A computer system as claimed in claim 1 wherein the order generator's device and a server of the computer system are a single unitary device.

6. A computer system as claimed in claim 1 wherein the message and/or the unverified code are encrypted.

7. A computer system as claimed in claim 1 wherein the person to be billed is in substantially real time communication with the order generator.

8. A method of secure data transfer between unsecured parties in a system comprising: a server, a database, and network communications;
the method comprising the steps of:
receiving order details from an order generator, the order details comprising at least:
Person to be billed's information, and
Order information;
storing the order details in the database;
generating a unique order transfer code and assigning the unique order transfer code to the order details recorded in the database using the Person to billed's information to generate a message to a Person to be billed;
sending the message containing the unique order transfer code to the Person to be billed;
requesting the Person to be billed to return the unique order transfer code;
checking a received unverified code against the unique transfer code held in the record and verifying the unique order transfer code, then either
rejecting the unique order transfer code as false and denying access to the Person to be billed, or
accepting the unique order transfer code and forwarding the Person to be billed to a payment platform to complete the transaction; and
awaiting confirmation of successful payment from the payment platform and generating and sending a communication of the successful payment to the order generator.

9. A method of secure data transfer between unsecured parties as claimed in claim 8 wherein the order details further comprise any of the information from the following list: first name of the person to be billed; second name of the person to be billed; the billing address; the phone number of the person being billed; the order recipient's first name; the order recipient's second name; the order recipient's address; an email address; a description of the transaction; the currency; the amount of the transaction.

10. A method of secure data transfer between unsecured parties as claimed in claim 9 wherein the billing address and the delivery address refer to different geographical locations.

11. A method of secure data transfer between unsecured parties as claimed in claim 8 wherein the system is part of an online network.

12. A method of secure data transfer between unsecured parties as claimed in claim 8 wherein the order generator's device and the server are a single unitary device.

13. A method of secure data transfer between unsecured parties as claimed in claim 8 wherein the method is encrypted.

14. A method of secure data transfer between unsecured parties as claimed in claim 8 wherein the person to be billed in substantially real time communication with the order generator.

15. A method of secure data transfer between unsecured parties as claimed in claim 8 wherein at least part of the method is implemented on either a smart mobile telephone or a tablet computer device.

16. A computer terminal for use with a computer system for secure data transfer between unsecured parties, the terminal being configured to:
receive a message in relation to a person to be billed associated with a transaction associated with a telephone order, the message containing a unique order transfer code;
request the person to be billed to return the unique order transfer code; and
send the unique order transfer code to a computer system to complete the transaction.

17. A computer terminal according to claim 16, wherein the computer terminal is a smart phone, tablet computer, laptop computer or desktop computer.

18. (canceled)

19. (canceled)
